(19) United States
(12) Patent Application Publication
(10) Pub. No.: US 2026/0275885 A1
(43) Pub. Date: Sep. 17, 2026

(54) TURBINE FOR AN AIRCRAFT GENERATING SWIRL IN EXHAUST GASES

(71) Applicant: General Electric Company, Evendale, OH (US)

(72) Inventors: Brandon W. Miller, Middletown, OH (US); Arthur W. Sibbach, Boxford, MA (US); Abhishek Khatta, Jawalamukhi (IN); Rimple Rangrej, Raipur (IN); Krishna Ramadurai, Bengaluru (IN); Avinash Natarajan, Bengaluru (IN); Ravindra Shankar Ganiger, Bengaluru (IN); Erich Alois Krammer, West Chester, OH (US); Gontla Nagashiresha, Bengaluru (IN)

(21) Appl. No.: 19/040,258

(22) Filed: Jan. 29, 2025

(51) Int. Cl. F01D 25/30

(52) U.S. Cl. CPC F01D 25/30; F05D 2240/127

(57) ABSTRACT

A turbine engine for an aircraft. The turbine engine includes a combustor, an exhaust section, and one or more swirl features. The combustor combusts a fuel and air mixture, and generates combustion gases flowing along a flow path. The exhaust section is downstream of the combustor. The exhaust section receives the combustion gases and exhausts the combustion gases from the turbine engine as exhaust gases flowing along a flow path. The one or more swirl features extend into the flow path of the combustion gases or the flow path of the exhaust gases. The one or more swirl features generate swirl in the exhaust gases to create swirl in an exhaust of the turbine engine.

### TECHNICAL FIELD

The present disclosure relates generally to a turbine engine, particularly, to a turbine engine for an aircraft generating swirl in exhaust gases.

### BACKGROUND

Turbine engines, for example, for aircraft, generally include a fan and a turbo-engine arranged in flow communication with one another. A combustor is arranged in the turbo-engine to generate combustion gases for driving a turbine in the turbo-engine of the turbine engine. The combustion gases are then typically exhausted from the turbine engine to the atmosphere.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, or structurally similar elements.

FIG. 1 is a schematic cross-sectional view of a turbine engine, taken along a centerline axis of the turbine engine, according to the present disclosure.

FIG. 2 is a schematic diagram of an exhaust section of the turbine engine having a contrail mitigation system, according to the present disclosure.

FIG. 3A is a schematic diagram of the exhaust section of the turbine engine having a contrail mitigation system in a closed position, according to another embodiment.

FIG. 3B is a schematic diagram of the exhaust section of the turbine engine having the contrail mitigation system of FIG. 3A in an opened position, according to the present disclosure.

FIG. 4 is a schematic diagram of the exhaust section of the turbine engine having a contrail mitigation system in an opened position, according to another embodiment.

FIG. 5 is a schematic diagram of the exhaust section of the turbine engine having a contrail mitigation system in an opened position, according to another embodiment.

FIG. 6A is a schematic diagram of the exhaust section of the turbine engine having a contrail mitigation system in a closed position, according to another embodiment.

FIG. 6B is a schematic diagram of the exhaust section of the turbine engine having the contrail mitigation system of FIG. 6A in a partially opened position, according to another embodiment.

FIG. 6C is a schematic diagram of the exhaust section of the turbine engine having the contrail mitigation system of FIGS. 6A and 6B in an opened position, according to another embodiment.

FIG. 7 is a rear view of the turbine engine mounted on an aircraft and having a contrail mitigation system in an opened position, according to another embodiment.

FIG. 8A is a schematic diagram of the exhaust section of the turbine engine having a contrail mitigation system in a closed position, according to another embodiment.

FIG. 8B is a schematic diagram of the exhaust section of the turbine engine having the contrail mitigation system of FIG. 8A in an opened position, according to the present disclosure.

FIG. 9A is a schematic diagram of the exhaust section of the turbine engine having a contrail mitigation system in a closed position, according to another embodiment.

FIG. 9B is a schematic diagram of the exhaust section of the turbine engine having the contrail mitigation system of FIG. 9A in an opened position, according to the present disclosure.

FIG. 10 is a schematic view of a control system for the turbine engine, according to the present disclosure.

FIG. 11 is a flowchart of a method of controlling a turbine engine to mitigate contrail formation, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” etc., may be used interchangeably to distinguish one component from another and are not intended to signify location or importance of the individual components.

The terms “upstream” and “downstream” refer to the relative direction with respect to air flow through the engine. For example, “upstream” refers to the direction from which air flows into the engine, and “downstream” refers to the direction to which the air flows out of the engine.

The terms “forward” and “aft” refer to relative positions within a turbine engine or vehicle and refer to the normal operational attitude of the turbine engine or vehicle. For example, with regard to a turbine engine, forward refers to a position on the turbine engine that is closer to the propeller or the fan, and aft refers to a position on the turbine engine that is farther away from the propeller or the fan. When the turbine engine is configured in a pusher configuration, the propeller or the fan is positioned on an aft side of the turbine engine such that forward refers to a position that is farther away from the propeller or the fan and aft refers to a position that is closer to the propeller or the fan.

As used herein, the terms “axial” and “axially” refer to directions and orientations that extend substantially parallel to a longitudinal centerline of the turbine engine. Moreover, the terms “radial” and “radially” refer to directions and orientations that extend substantially perpendicular to the longitudinal centerline of the turbine engine. In addition, as used herein, the terms “circumferential” and “circumferentially” refer to directions and orientations that extend arcuately about the longitudinal centerline of the turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, “combustion gases” result from the combustion of fuel and air in the engine.

As used herein, “exhaust gases” are gases of an exhaust of an engine, and the exhaust gases include the combustion gases during and after exiting the jet exhaust nozzle section.

As used herein, “contrails” are vapor trails that form when the combustion gases from the turbine engine mix with cold air surrounding the turbine engine as the combustion gases are discharged from the turbine engine as the exhaust gases.

As used herein, “contrail conditions” are atmospheric conditions, turbine engine operating conditions, or aircraft conditions that are suitable for the formation of contrails. For instance, contrail conditions may include ambient temperature, altitude, ambient humidity, air pressure, air speed of the aircraft, turbine engine speed, or any atmospheric conditions, turbine engine operating conditions, or aircraft conditions suitable for contrail formation. “Humidity” refers to the ambient humidity, rather than exhaust gas humidity.

As used herein, a “swirl feature” or “swirl features” include a component that generates swirl in an exhaust flow of the turbine engine. For example, the swirl features herein can include vanes, flaps, fins, vortex generators, or the like, for generating swirls in the exhaust as the exhaust flows from the turbine engine. The swirl features herein can be stationary or movable.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

As discussed above, the turbine engine exhausts combustion gases. Combustion gases comprise gases resulting from combustion in the combustion chamber and flowing out of the engine after combustion, wherein the combustion gases are exhaust gases during and after the combustion gases are exhausted from the engine. These relatively hot combustion gases may include water vapor. When the turbine engine is used with an aircraft, the combustion gases mix with the cold air surrounding the engine as the combustion gases are discharged from the turbine engine as the exhaust gases, and the water vapor condenses under certain atmospheric conditions forming contrails. Particles in the exhaust gases form nucleation or condensation points for the water vapor, promoting contrail formation. Contrails trap outgoing longwave radiation emitted by the Earth and the atmosphere and may thus contribute to climate change.

Accordingly, the present disclosure provides for a contrail mitigation system to reduce the residence time of particles in the exhaust gases and, thus, reduce contrail formation. The contrail mitigation system can be activated when contrails are detected or conditions are such that contrail formation is likely. More specifically, in embodiments discussed herein, the contrail mitigation system purposely generates swirls or vortices in the exhaust gases exiting the turbo-engine to reduce the residence time of the particles in the exhaust gases that serve as the nucleation sites for forming the contrails. In this way, the contrail mitigation system reduces or prevents the contrails from forming, and, thus, reduces climate warming impacts of aircraft propulsion operation.

In some embodiments, the contrail mitigation system creates swirl in the exhaust stream of the core turbine exit. Typically, turbine engines are designed to reduce or to prevent swirls in the exhaust, as swirls reduce an amount of axial thrust generated by the exhaust, and, thus, there is a significant fuel burn penalty if there are swirls in the exhaust. Therefore, in some embodiments, the contrail mitigation system generates the swirls in response to a contrail condition in order to reduce the fuel burn associated with the swirls when there are no contrail conditions or potential contrail conditions.

In some embodiments, the contrail mitigation system includes swirl features, such as, for example, vanes, fins, flaps, ribs, bumps, vortex generators, or the like, on the turbo-engine casing near the exhaust section or on the tail cone. The swirl features can be stationary or movable by direct driving means or indirect driving means. The swirl features induce vortical disturbances (e.g., vortices) in the exhaust and, thus, deprive the region of the required residence time for moisture to condense on the nucleation sites (soot, dust etc.). The swirl features on an exhaust gas path are controlled and actuated based on a signal from sensors mounted on the exterior of the aircraft or from an avionics system onboard the aircraft to measure the ambient properties of the atmosphere and to detect onset of conditions conducive to contrail formation. In some embodiments, the swirl features can be deployed on demand when a presence of contrails is indicated. Thus, the swirl features do not substantially diminish the efficiency of the overall mission. In some embodiments, the power required to actuate the swirl features can be extracted from the low-pressure turbine (LP) shaft or the high-pressure turbine (HP) shaft, and, thus, reduces the need for additional arrangements for the required power. In embodiments, a system and a method are provided for an open loop control system to mitigate contrails of the turbine engine. The contrail mitigation system of the open loop control system includes swirl features that create one or more angles with the radial direction of the surface on which each swirl feature extends.

Embodiments of the present disclosure include swirl features on components in aft regions of the engine, such as an exhaust section. In some embodiments, the swirl features are exit vanes that have a trailing edge that is not axially straight. In some embodiments, the exit vanes are more specifically turbine rear frame (TRF) exit vanes. In some embodiments, the low-pressure turbine generates swirl in the exhaust. Thus, the swirl features are more specifically low-pressure turbine (LP) exit vanes. For example, the LP exit vanes are angled with respect to the axial direction to create swirl in the exhaust. In other embodiments, one or more components of the engine generate swirl without swirl features, and the swirl is maintained. Thus, the swirl is intentionally left in the flow path of the exhaust gases or the flow path of the combustion gases, resulting in contrail mitigation. Further, vanes or struts may be angled with respect to the axial direction to prevent a mitigation of residual swirl generated by components of the engine, such as the LP turbine. Thus, struts or vanes that would normally be angled to reduce swirl in the exhaust generated by components such as the LP turbine are angled to not mitigate, or even to increase, the amount of swirl generated by the LP turbine. In some embodiments, the swirl features include vanes that are mounted on the tail cone, flush with the surface of the tail cone in the normal engine operation. The vanes are deployed when conditions favorable to contrail formation are sensed or are otherwise detected. Each swirl feature has a tip and a base. When in a closed position, both the base and the tip are flush with a surface, such as flush with the surface of the tail cone or another exhaust component. When in an opened position, the tip extends radially upward from the surface.

In some embodiments, the swirl features are foldable. In some embodiments, the swirl features are distributed circumferentially or in some pattern along the surface of the casing or the tail cone. Such a distribution may maximize an impact of the swirl features on contrail formation. In some embodiments, the swirl features are located at a fan nozzle bypass exit to impart a tangential velocity to the airflow as the airflow exits the turbine engine.

In some embodiments, the swirl features extend radially inward from the surface of the turbine rear frame into the hot gas path. In some embodiments, the swirl features are on the outer casing and extend into a flow path of bypass air. In some embodiments, the swirl features are on an exhaust casing surface, such as an exhaust casing inside surface or an exhaust casing outside surface.

In some embodiments, the swirl features include fins that are mounted on the engine at various locations and induce wakes in the exhaust flow. The fins can be positioned radially from the surface of the tail cone. In some embodiments, the fins extend from an aft end of the tail cone.

Accordingly, the contrail mitigation system of the present disclosure creates swirl in an exhaust of the turbine engine by generating swirl in the exhaust gases, generating swirl in the combustion gases, or both, as the combustion gases are exhausted from the turbine engine as exhaust gases. The swirls prevent residence time for moisture to condense on nucleation sites and, thus, prevent contrails from forming.

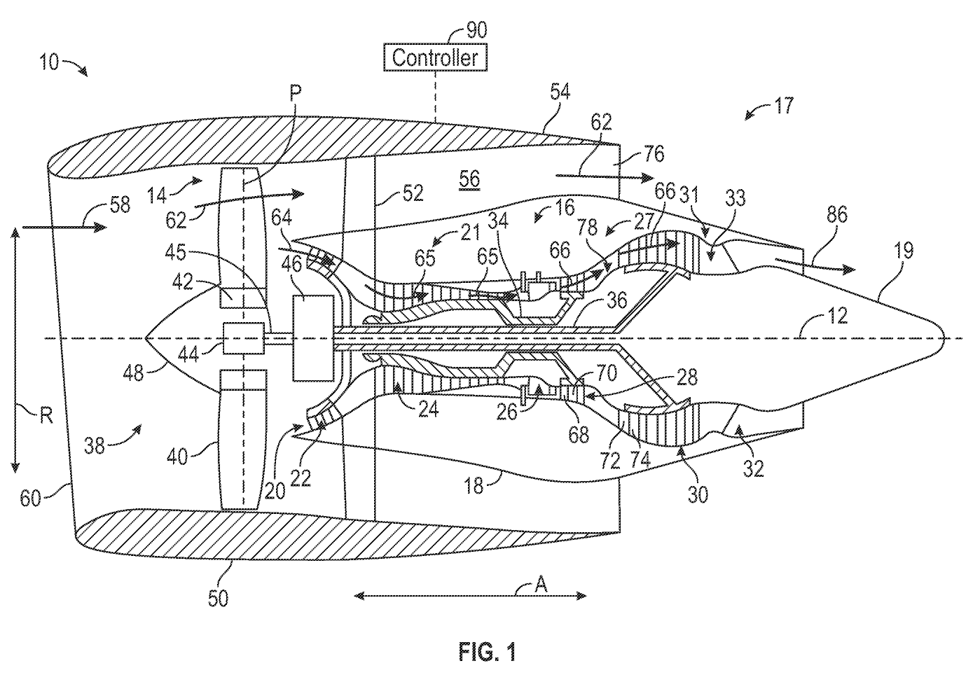

Referring now to the drawings, FIG. 1 is a schematic cross-sectional diagram of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14. The turbine engine 10 also includes an exhaust section 17 from which bypass air 62 and combustion gases 66 are exhausted from the turbine engine 10 and generate thrust, as detailed further below. The exhaust section 17 includes a tail cone 19 at an aft end of the turbine engine 10. The tail cone 19 provides an aerodynamic surface that helps to smooth the flow of the combustion gases 66 from the turbine engine 10.

The turbo-engine 16 includes, in serial flow relationship, a compressor section 21, a combustor 26, and a turbine section 27. The turbo-engine 16 is substantially enclosed within an outer casing 18 that is substantially tubular and defines a core inlet 20 that is annular about the longitudinal centerline axis 12. As schematically shown in FIG. 1, the compressor section 21 includes a booster or a low pressure (LP) compressor 22 followed downstream by a high pressure (HP) compressor 24. The combustor 26 is downstream of the compressor section 21. The turbine section 27 is downstream of the combustor 26 and includes a high pressure (HP) turbine 28 followed downstream by a low pressure (LP) turbine 30. A turbine rear frame 31 is disposed downstream of the LP turbine 30 and includes a mounting surface for mounting the turbine engine 10 to an aircraft. The turbine rear frame 31 includes a plurality of struts 33 mounted within the outer casing 18. The plurality of struts 33 provides a rigid surface between the outer casing 18 and the internal components of the turbo-engine 16, as well as can turn the airflow exiting the turbo-engine 16 to generate swirls in the airflow, as detailed further below.

The turbo-engine 16 further includes a jet exhaust nozzle section 32 that is downstream of the turbine section 27, a high-pressure (HP) shaft 34 or a spool, and a low-pressure (LP) shaft 36. The jet exhaust nozzle section 32 forms a part of the exhaust section 17. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustor 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. In the case of a variable pitch fan, the plurality of fan blades 40 are rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment shown in FIG. 1, the disk 42 is covered by a fan hub 48 that is aerodynamically contoured to promote an airflow through the plurality of fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. The pressure of core air 64 is then increased, generating compressed air 65. The compressed air 65 is routed through the HP compressor 24 and into the combustor 26, where the compressed air 65 is mixed with fuel and ignited to generate the combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, and, thus, supports operation of the HP compressor 24 (self-sustaining cycle). In this way, the combustion gases 66 do work on the HP turbine 28. The combustion gases 66 are then routed into the LP turbine 30 and expanded through the LP turbine 30. Here, a second portion of the thermal energy or the kinetic energy is extracted from the combustion gases 66 via one or more stages of LP turbine stator vanes 72 and LP turbine rotor blades 74 that are coupled to the LP shaft 36. This causes the LP shaft 36 to rotate, and, thus, supports operation of the LP compressor 22 (self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. The combustion gases 66 exit the jet exhaust nozzle section as exhaust gases 86. Simultaneously, the bypass air 62 is routed through the bypass airflow passage 56 before being exhausted from a fan nozzle exhaust section 76 of the turbine engine 10, also providing propulsive thrust. The fan nozzle exhaust section 76 forms a part of the exhaust section 17. The HP turbine 28, the LP turbine 30, and the jet exhaust nozzle section 32 at least partially define a hot gas path 78 for routing the combustion gases 66 through the turbo-engine 16.

A controller 90 is in communication with the turbine engine 10 for controlling aspects of the turbine engine 10. For example, the controller 90 is in two-way communication with the turbine engine 10 for receiving signals from various sensors and control systems of the turbine engine 10 and for controlling components of the turbine engine 10, as detailed further below. The controller 90, or components thereof, may be located onboard the turbine engine 10, onboard the aircraft, or can be located remote from each of the turbine engine 10 and the aircraft. The controller 90 can be a Full Authority Digital Engine Control (FADEC) that controls aspects of the turbine engine 10.

The controller 90 may be a standalone controller or may be part of an engine controller to operate various systems of the turbine engine 10. In this embodiment, the controller 90 is a computing device having one or more processors and a memory. The one or more processors can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory can include one or more computer-readable media, including, but not limited to, non-transitory computer-readable media, a computer readable non-volatile medium (e.g., a flash memory), a RAM, a ROM, hard drives, flash drives, or other memory devices.

The memory can store information accessible by the one or more processors, including computer-readable instructions that can be executed by the one or more processors. The instructions can be any set of instructions or a sequence of instructions that, when executed by the one or more processors, cause the one or more processors and the controller 90 to perform operations. The controller 90 and, more specifically, the one or more processors are programmed or configured to perform these operations, such as the operations discussed further below. In some embodiments, the instructions can be executed by the one or more processors to cause the one or more processors to complete any of the operations and functions for which the controller 90 is configured, as will be described further below. The instructions can be software written in any suitable programming language or can be implemented in hardware. Additionally, or alternatively, the instructions can be executed in logically or virtually separate threads on the processors. The memory can further store data that can be accessed by the one or more processors.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, or turboprop engines.

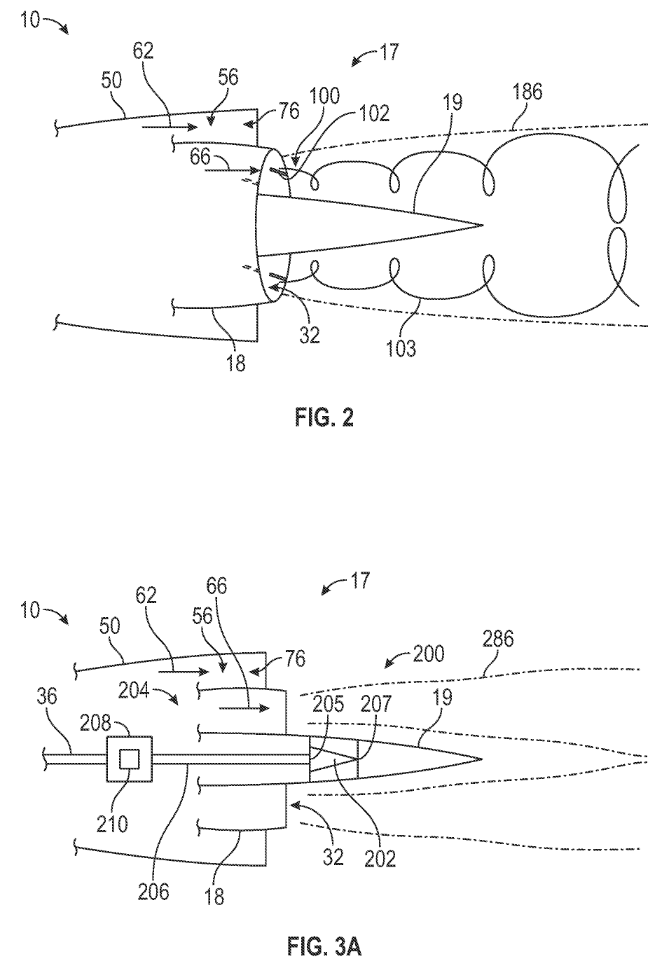

FIG. 2 is a schematic diagram of the exhaust section 17 of the turbine engine 10 having a contrail mitigation system 100, according to the present disclosure. The contrail mitigation system 100 includes one or more swirl features 102. Four swirl features 102 are illustrated in FIG. 2 (two in solid lines and two in dashed lines being illustrated on the interior of the outer casing 18), but the one or more swirl features 102 can include any number of swirl features 102, as necessary, for generating swirls in a cone of exhaust gases 186 that are exhausted from the turbine engine 10. In FIG. 2, the swirl features 102 are vanes. The swirl features 102 are mounted to the outer casing 18 in the jet exhaust nozzle section 32. In some embodiments, the swirl features 102 can be mounted on the tail cone 19 within the jet exhaust nozzle section 32. The swirl features 102 extend radially into the hot gas path 78 within the jet exhaust nozzle section 32 and are angled with respect to the axial direction A to generate swirls 103 in the cone of exhaust gases 186 as the combustion gases 66 flow out of the turbine engine 10. For example, the angle is greater than zero (0) degrees and less than ninety (90) degrees. The swirl features 102 are spaced circumferentially about the outer casing 18.

In some embodiments, the swirl features 102 are the struts 33 (FIG. 1) of the turbine rear frame 31 and are disposed at an angle with respect to the axial direction A to generate the swirls 103. In other embodiments, the swirl features are low-pressure turbine (LP) exit vanes. Further, the LP exit vanes are angled with respect to the axial direction to create swirl in the exhaust.

In other embodiments, one or more components of the turbine engine 10 generate swirls without swirl features being used (not shown), and the swirls are maintained such that the swirls are intentionally left in the flow path of the exhaust gases 86 or the flow path of the combustion gases 66, resulting in contrail mitigation. For example, the contrail mitigation system 100 can include the LP turbine 30 generating swirls in the combustion gases 66 within the LP turbine 30 during operation and exhausting the swirls from the exhaust section 17. In further embodiments, the LP exit vanes or the struts are angled with respect to the axial direction to prevent a mitigation of the swirls generated by the components (e.g., the LP turbine 30) of the turbine engine 10, maintaining or increasing the amount of swirl in the combustion gases 66 once the combustion gases 66 flow past the LP exit vanes or the struts.

In operation, the turbine engine 10 generates the combustion gases 66, as detailed above with respect to FIG. 1. The combustion gases 66 flow through the jet exhaust nozzle section 32 and flow over the swirl features 102 and, thus, generate the swirl 203 in the cone of exhaust gases 186 as the combustion gases 66 are exhausted from the turbine engine 10. The swirl features 102, thus, generate the swirls 103 as the combustion gases 66 flow past the swirl features 102. In some embodiments, the contrail mitigation system 100 generates swirls without the use of the swirl features 102. For example, the LP turbine 30 generates the swirls in the combustion gases 66 during operation, and the contrail mitigation system 100 exhausts the swirls generating by the LP turbine 30 from the exhaust section 17.

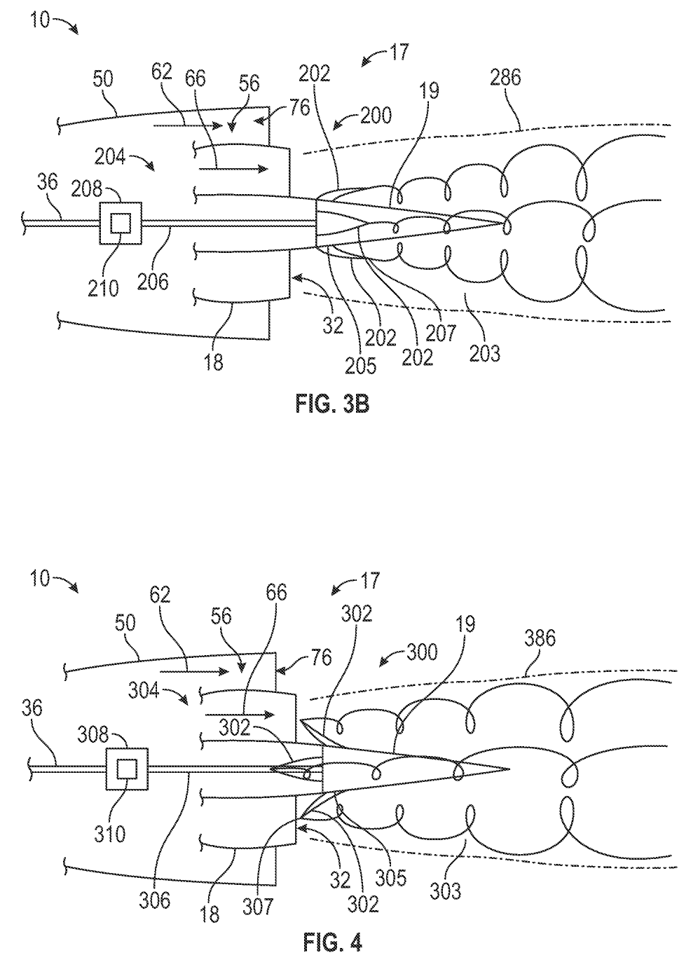

FIG. 3A is a schematic diagram of the exhaust section 17 of the turbine engine 10 having a contrail mitigation system 200 in a closed position, according to another embodiment. FIG. 3B is a schematic diagram of the exhaust section 17 of the turbine engine 10 having the contrail mitigation system 200 in an opened position, according to the present disclosure.

The contrail mitigation system 200 includes one or more swirl features 202. The swirl features 202 are vanes mounted in the exhaust section 17. In some embodiments, the swirl features 202 can be flaps, fins, claws, or any other kind of swirl feature for generating swirls in a cone of exhaust gases 286. In FIGS. 3A and 3B, the swirl features 202 are mounted to the tail cone 19. The swirl features 202 extend from a base 205 to a tip 207. The tip 207 is downstream of the base 205. The swirl features 202 are rotatably coupled to the tail cone 19 such that the swirl features 202 rotate from the closed position to the opened position, and from the opened position to the closed position. The swirl features 202 can be opened to any position between the closed position and the opened position. The swirl features 202 are rotatably coupled to the tail cone 19 at the base 205 of the swirl features 202. For example, the base 205 can include a hinge, or the like, such that the swirl features 202 can pivot about the base 205 from the closed position to the opened position, as detailed further below.

The contrail mitigation system 200 includes an actuator 204. The actuator 204 is a rotary actuator that rotates a portion of the exhaust section 17 on which the swirl features 202 are mounted. For example, the actuator 204 rotates the tail cone 19 or a portion of the tail cone 19. The rotation of the actuator 204 allows for the opening of the swirl features 202 for generating the swirl 203. The actuator 204 includes an actuator shaft 206 drivingly coupled to a turbine shaft (e.g., the LP shaft 36 or the HP shaft 34) of the turbine engine 10. Thus, rotation of the turbine shaft rotates the actuator shaft 206 and causes the actuator 204 to rotate the portion of the exhaust section 17 (e.g., the tail cone 19). In FIGS. 3A and 3B, the actuator shaft 206 is drivingly coupled to the LP shaft 36. The actuator shaft 206 is coupled to the turbine shaft through a gear assembly 208. The gear assembly 208 reduces a speed of the actuator shaft 206 from a speed of the turbine shaft. The actuator 204 includes a clutch 210 that engages the actuator shaft 206 to the turbine shaft or disengages the actuator shaft 206 from the turbine shaft. In the closed position, the clutch 210 disengages the actuator shaft 206 from the turbine shaft. In some embodiments, the actuator may be a pneumatic actuator, a hydraulic actuator, an electric actuator, a smart material actuator, a shape-memory-alloy-based actuator, or any actuator that operates based upon mechanical means directly or indirectly from one or more components of the turbine engine.

In operation, the actuator 204 controls the clutch 210 to disengage the actuator shaft 206 from turbine shaft in the closed position (FIG. 3A). In the closed position, the swirl features 202 (e.g., the tip 207 of the swirl features 202) are prevented from generating the swirls 203. For example, the swirl features 202 are flush with the surface of the tail cone 19 such that the combustion gases 66 flow smoothly over the tail cone 19. In this way, the tip 207 forms a portion of the surface of the tail cone 19 when the swirl features 202 are in the closed position. In some embodiments, the swirl features 202 can be stored within the tail cone 19 in the closed position such that the tip 207 is below the surface of the tail cone 19.

In certain conditions, contrails may form as the combustion gases 66 are exhausted from the turbine engine 10 as exhaust gases 86. In such conditions, the contrail mitigation system 200 opens the swirl features 202 to the opened position. In particular, the contrail mitigation system 200 controls the clutch 210 to engage the actuator shaft 206 to the turbine shaft. Thus, rotation of the turbine shaft causes the actuator shaft 206 to rotate and, in turn, causes the portion of the exhaust section 17 (e.g., the tail cone 19 or the portion of the tail cone 19) to rotate. The rotation of the tail cone 19 (e.g., a centrifugal force due to the rotation) causes the swirl features 202 to pivot about the base 205, thus opening the swirl features 202 to the opened position. In the opened position, the swirl features 202 extend radially from the surface of the tail cone 19 into the flow path of the combustion gases 66. In particular, the tip 207 is disposed within the flow path of the combustion gases 66 in the opened position. The combustion gases 66 flow over the swirl features 202 and the swirl features 202 generate the swirls 203 in the cone of exhaust gases 286.

In some embodiments, a motor rotates the actuator shaft 206 to rotate the tail cone 19, or a rotary actuator that is not connected to the LP shaft 36 rotates the tail cone 19. In further embodiments, how much the swirl features 202 open is proportional to the speed that the tail cone 19 rotates. Hence, the motor or the rotary actuator modulates the openness of the swirl features 202 on the tail cone 19. In further embodiments, the openness of the swirl features 202 on the tail cone 19 determines the amount of swirl in the exhaust gases 86. For instance, the swirl features 202, when fully open, may provide the maximum amount of swirl in the exhaust gases 86 due to openness of the swirl features 202, whereas the swirl features 202, when partially open, may provide less swirl than the swirl features 202, when fully open. In some embodiments, a speed that the swirl features 202 spin in the flow path of the combustion gases 66, due to a speed that the tail cone 19 spins, affects the amount of swirl produced in the exhaust gases 86. In some embodiments, a fastest speed of which the tail cone spins creates a maximum amount of swirl in the exhaust gases 86. In some embodiments, a speed slower than the fastest speed of which the tail cone spins creates an amount of swirl less than the maximum amount of swirl in the exhaust gases 86. Therefore, the contrail mitigation system 200 can modulate an amount of the swirl 203 by controlling the rotational speed of the portion of the exhaust section 17 via the actuator shaft 206 and, thus, the amount that the swirl features 202 extend from the exhaust section 17 into the flow path of the combustion gases 66.

FIG. 4 is a schematic diagram of the exhaust section 17 of the turbine engine 10 having a contrail mitigation system 300 in an opened position, according to another embodiment. The contrail mitigation system 300 is substantially similar to the contrail mitigation system 200 shown in FIGS. 3A and 3B. The same reference numerals or similar reference numerals will be used for components of the contrail mitigation system 300 that are the same as or similar to the components of the contrail mitigation system 200 discussed above. The description of these components above also applies to this embodiment, and a detailed description of these components is omitted here.

The contrail mitigation system 300 includes one or more swirl features 302 that extend from a base 305 to a tip 307 for generating swirls 303. The contrail mitigation system 300 also includes an actuator 304 having an actuator shaft 306, a gear assembly 308, and a clutch 310. The swirl features 302 are substantially similar as the swirl features 202 shown in FIGS. 3A and 3B. In FIG. 4, however, the tip 307 is disposed upstream of the base 305, and the tip 307 may create greater turbulence generation when compared to the tip 207 due to the tip 307 being pointed into a flow path of the exhaust gases 86 more than the tip 207. The contrail mitigation system 300 operates substantially similar as the contrail mitigation system 200 to open the swirl features 302 to generate the swirls 303 in a cone of exhaust gases 386.

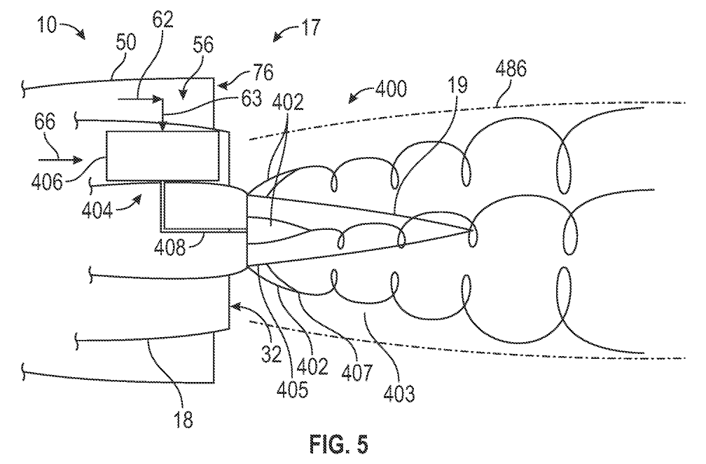

FIG. 5 is a schematic diagram of the exhaust section 17 of the turbine engine 10 having a contrail mitigation system 400 in an opened position, according to another embodiment. The contrail mitigation system 400 is substantially similar to the contrail mitigation system 200 shown in FIGS. 3A and 3B. The same reference numerals or similar reference numerals will be used for components of the contrail mitigation system 400 that are the same as or similar to the components of the contrail mitigation system 200 discussed above. The description of these components above also applies to this embodiment, and a detailed description of these components is omitted here.

The contrail mitigation system 400 includes one or more swirl features 402 that extend from a base 405 to a tip 407 for generating swirls 403. The contrail mitigation system 400 also includes an actuator 404 that is different than the actuator 204 shown in FIGS. 3A and 3B for opening and for closing the swirl features 402.

The actuator 404 is a linear actuator that opens the swirl features 402 linearly without rotating the exhaust section 17 (e.g., the tail cone 19). The actuator 404 is a pneumatic actuator that actuates the swirl features 402 to open and to close the swirl features 402 by air. In particular, the actuator 404 includes an actuator valve 406 and an actuator flow path 408. The actuator flow path 408 is in fluid communication with the bypass airflow passage 56, and the actuator valve 406 is in fluid communication with the actuator flow path 408. In other embodiments, the actuator 404 can include any other type of linear actuator, such as, for example, a hydraulic actuator, an electric actuator, a smart material actuator, a shape-memory-alloy-based actuator, or any actuator that operates based upon mechanical means directly or indirectly from one or more components of the turbine engine.

In operation, the contrail mitigation system 400 controls the actuator valve 406 to close the actuator valve 406 to prevent air from flowing through the actuator flow path 408 to close the swirl features 402 to the closed position. To open the swirl features 402, the contrail mitigation system 400 controls the actuator valve 406 to open. When the actuator valve 406 is opened, the bypass air 62 flows into the actuator 404 as actuator air 63. The actuator flow path 408 directs the actuator air 63 towards the swirl features 402 to open the swirl features 402 to the opened position and, thus, to generate the swirls 403. In some embodiments, the actuator 404 modulates the actuator valve 406 to modulate an amount of actuator air 63 to the swirl features 402. In this way, the actuator 404 controls an amount of the radial extension of the swirl features 402 when the swirl features 402 are open, such that the swirl features 402 can open partially (e.g., between the closed position and the opened position) to generate the swirls 403 in a cone of exhaust gases 486.

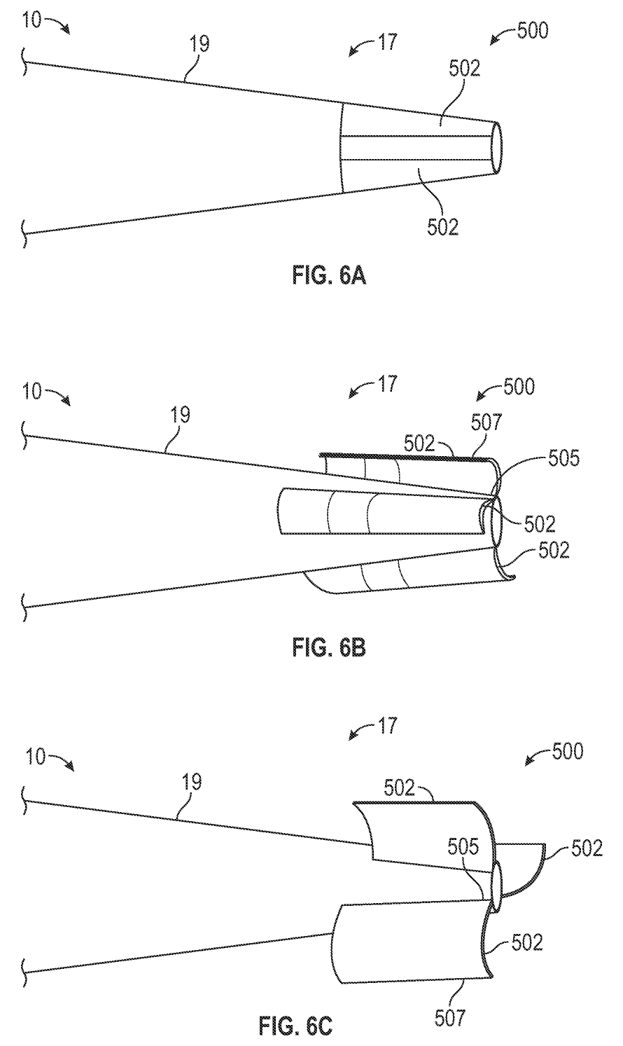

FIG. 6A is a schematic diagram of the exhaust section 17 of the turbine engine 10 having a contrail mitigation system 500 in a closed position, according to another embodiment. FIG. 6B is a schematic diagram of the exhaust section 17 of the turbine engine 10 having the contrail mitigation system 500 in a partially opened position, according to another embodiment. FIG. 6C is a schematic diagram of the exhaust section 17 of the turbine engine 10 having the contrail mitigation system 500 in an opened position, according to another embodiment. The contrail mitigation system 500 is substantially similar to the contrail mitigation system 200 shown in FIGS. 3A and 3B. The same reference numerals or similar reference numerals will be used for components of the contrail mitigation system 500 that are the same as or similar to the components of the contrail mitigation system 200 discussed above. The description of these components above also applies to this embodiment, and a detailed description of these components is omitted here.

The contrail mitigation system 500 includes one or more swirl features 502 mounted in the exhaust section 17. In particular, the swirl features 502 are flaps mounted on the tail cone 19. The swirl features 502 extend from a base 505 to a tip 507. The swirl features 502 include a general arc shape such that the swirl features 502 extend circumferentially about the exhaust section 17 (e.g., the tail cone 19). The swirl features 502 are mounted to the tail cone 19 such that swirl features 502 open in the circumferential direction to extend radially into the flow path of the combustion gases 66. The contrail mitigation system 500 operates substantially similar to the contrail mitigation system 200 to open the swirl features 502 to the opened position to generate swirls in the exhaust gases 86 shown in FIG. 1. The contrail mitigation system 500 can include an actuator similar to the actuator 204 shown in FIGS. 3A and 3B for rotating the tail cone 19 to open the swirl features 502.

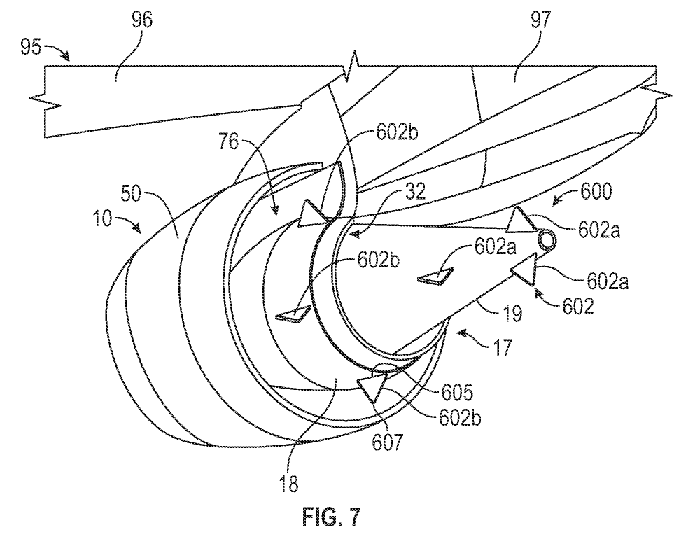

FIG. 7 is a rear view of the turbine engine 10 mounted on an aircraft 95 and having a contrail mitigation system 600 in an opened position, according to another embodiment. The aircraft 95 includes one or more wings 96. Each of the one or more wings 96 can include a turbine engine 10 mounted thereon by a pylon 97. The contrail mitigation system 600 is substantially similar to the contrail mitigation system 200 shown in FIGS. 3A and 3B. The same reference numerals or similar reference numerals will be used for components of the contrail mitigation system 600 that are the same as or similar to the components of the contrail mitigation system 200 discussed above. The description of these components above also applies to this embodiment, and a detailed description of these components is omitted here.

The contrail mitigation system 600 includes one or more swirl features 602. The swirl features 602 are fins and extend from a base 605 to a tip 607. The swirl features 602 include one or more first swirl features 602a and one or more second swirl features 602b. The first swirl features 602a are coupled to the tail cone 19. The second swirl features 602b are coupled to the outer casing 18 and extend into the bypass airflow passage 56 at the fan nozzle exhaust section 76. In this way, the first swirl features 602a generate swirls in the exhaust gases 86 (FIG. 1) and the second swirl features 602b generate swirls in the bypass air 62 (FIG. 1). The one or more swirl features 602 can be coupled to an actuator (e.g., any of the actuators detailed herein) such that the contrail mitigation system 600 can open and can close the one or more swirl features 602 to prevent contrails from forming.

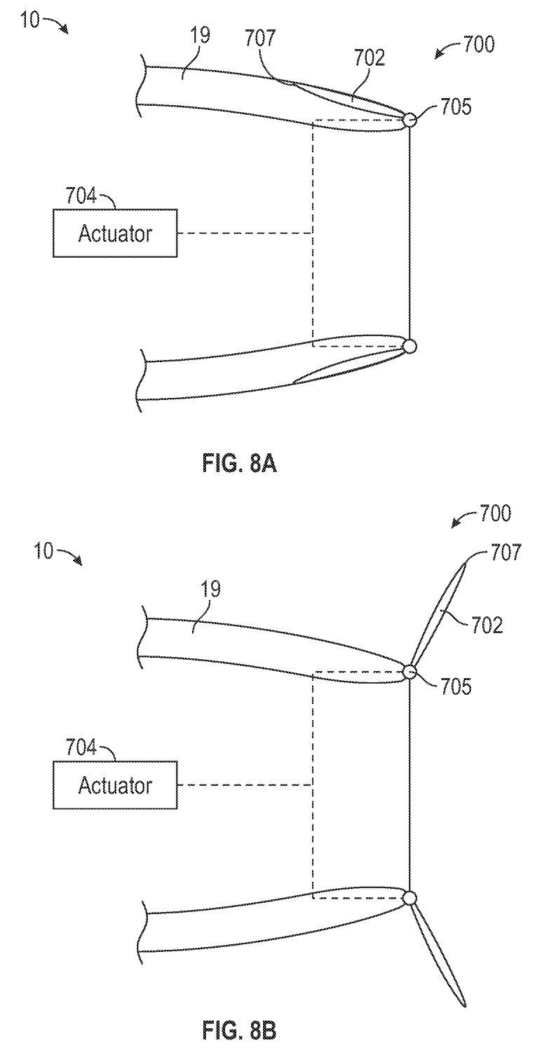

FIG. 8A is a schematic diagram of the tail cone 19 of the turbine engine having a contrail mitigation system 700 in a closed position, according to another embodiment. FIG. 8B is a schematic diagram of the tail cone 19 of the turbine engine 10 having the contrail mitigation system 700 in an opened position, according to the present disclosure. The contrail mitigation system 700 is substantially similar to the contrail mitigation system 200 shown in FIGS. 3A and 3B. The same reference numerals or similar reference numerals will be used for components of the contrail mitigation system 700 that are the same as or similar to the components of the contrail mitigation system 200 discussed above. The description of these components above also applies to this embodiment, and a detailed description of these components is omitted here.

The contrail mitigation system 700 includes one or more swirl features 702 that extend from a base 705 to a tip 707. The swirl features 702 are flaps mounted on the tail cone 19 such that the tip 707 is upstream of the base 705. The swirl features 702 open and close along the axial direction. In particular, the base 705 of the swirl features 702 is rotatably coupled to the tail cone 19 at an aft end of the tail cone 19. The contrail mitigation system 700 includes an actuator 704 (e.g., a linear actuator) that opens the swirl features 702 linearly without rotating the tail cone 19. In some embodiments, the actuator 704 is a rotary actuator (similar to the actuator 204 shown in FIGS. 3A and 3B) that rotates the tail cone 19 to open the swirl features 702 (e.g., via a centrifugal force due to the rotation). Thus, the contrail mitigation system 700 controls the swirl features 702 to open to the opened position (in which the tip 707 is radially spaced from the tail cone 19 and is disposed in a flow path of the exhaust gases 86 shown in FIG. 1) to generate the swirls and to close to the closed position (in which the tip 707 is flush with the surface of the tail cone 19).

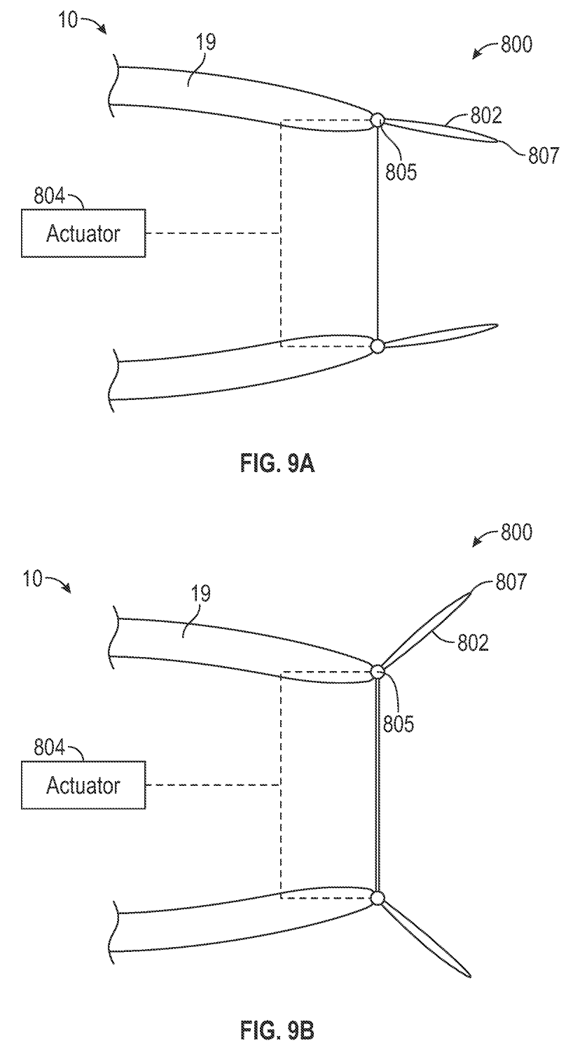

FIG. 9A is a schematic diagram of the tail cone 19 of the turbine engine 10 having a contrail mitigation system 800 in a closed position, according to another embodiment. FIG. 9B is a schematic diagram of the tail cone 19 of the turbine engine 10 having the contrail mitigation system 800 in an opened position, according to the present disclosure. The contrail mitigation system 800 is substantially similar to the contrail mitigation system 200 shown in FIGS. 3A and 3B. The same reference numerals or similar reference numerals will be used for components of the contrail mitigation system 800 that are the same as or similar to the components of the contrail mitigation system 200 discussed above. The description of these components above also applies to this embodiment, and a detailed description of these components is omitted here.

The contrail mitigation system 800 includes one or more swirl features 802 and an actuator 804 for opening and closing the swirl features 802. The swirl features 802 are flaps mounted on the tail cone 19. The swirl features 802 extend from a base 805 to a tip 807. The tip 807 is disposed downstream of the base 805. In particular, the swirl features 802 extend axially aft of an aft end of the tail cone 19 and form a portion of the aerodynamic surface of the tail cone 19. In the closed position, the swirl features 802 extend aftward from the aft end of the tail cone 19 in line with an inclining slope of the tail cone 19 such that the exhaust gases 86 shown in FIG. 1 flow smoothly over the aft end of the tail cone 19 and the swirl features 802. In the opened position, the swirl features 802 pivot about the base 805 such that the tip 807 moves radially outward such that the swirl features 802 are disposed in the flow path of the exhaust gases 86 shown in FIG. 1. The exhaust gases 86 then flow over the swirl features 802, and the swirl features 802 (e.g., the tip 807) generate swirls in the exhaust gases 86.

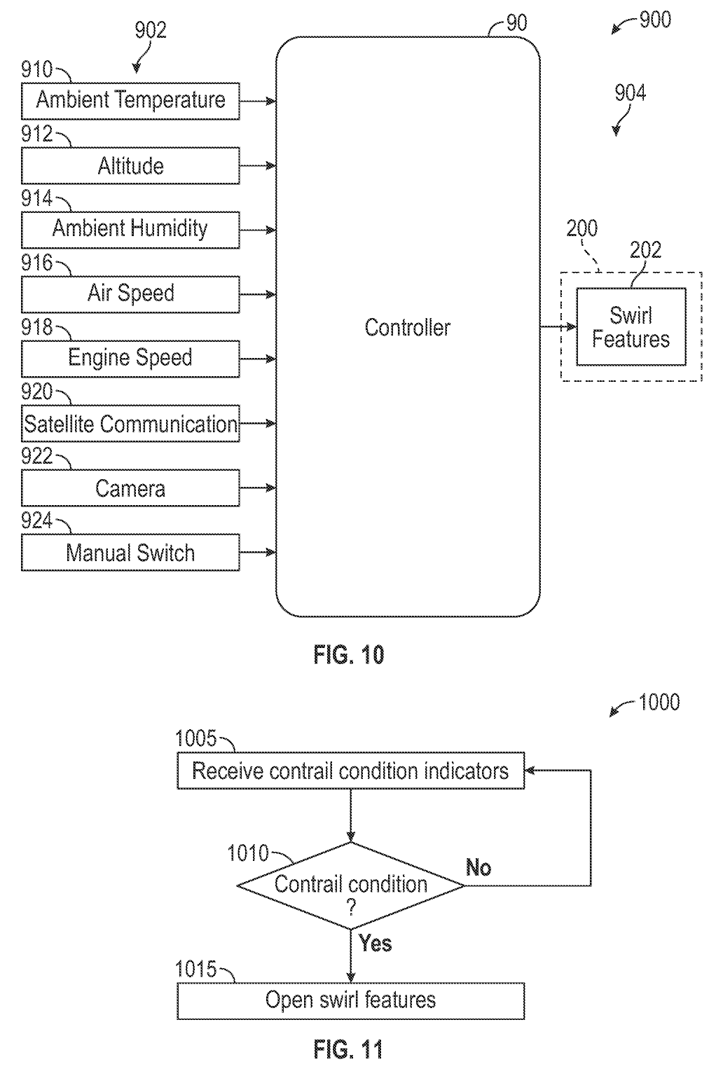

FIG. 10 is a schematic view of a control system 900 for the turbine engine 10, according to the present disclosure. While reference is made to the contrail mitigation system 200, the control system 900 can be utilized to control any of the contrail mitigation systems herein. The control system 900 includes inputs 902, the controller 90, and outputs 904. The inputs 902 include one or more contrail condition indicators including at least one of an ambient temperature 910, an altitude 912, an ambient humidity 914, an air speed 916, an engine speed 918, a satellite communication 920, a camera 922, or a manual switch 924. Each of the inputs 902 is sent to the controller 90 such that the controller 90 can control the swirl features 202 (e.g., the actuator 204) in response to a contrail condition.

The ambient temperature 910 is sensed by an ambient temperature sensor (e.g., a thermometer), the altitude 912 is sensed by an altitude sensor (e.g., an altimeter, or the like), and the ambient humidity 914 is sensed by a humidity sensor. The air speed 916 is sensed by one or more speed sensors on the aircraft 95. The engine speed 918 is sensed by one or more speed sensors on the turbine engine 10 for sensing a rotational speed of the turbine engine 10 (e.g., of the turbine shaft). The sensors send signals representing the respective sensed information to the controller 90.

The satellite communication 920 provides location data (e.g., via GPS), weather data, or the like, to the controller 90. In some embodiments, the camera 922 is mounted to the aircraft 95 and is rear facing. The camera 922 includes a display in a cockpit of the aircraft 95 or remote from the aircraft 95 for displaying a video feed or a camera feed of the camera 922 that shows contrails forming aft of the turbine engine 10. Thus, the camera 922 indicates to an operator of the aircraft 95 whether contrails are formed such that the operator can manually actuate the swirl features 202, such as by flipping a manual switch 924, or the like. In some embodiments, the camera 922 can be electrically connected to the controller 90, and the controller 90 can automatically detect contrails in the video feed from the camera 922 and actuate the swirl features 202. In some embodiments, the operator manually activates the swirl features 202 by actuating the manual switch 924. The manual switch 924 is located in the cockpit or can be remote from the aircraft 95 and the operator activates the manual switch 924 to open or to close the swirl features 202.

The outputs 904 include the contrail mitigation system 200. In particular, the outputs 904 include the swirl features 202. For instance, the controller may provide a signal to an actuator to control the actuator, such that the actuator opens or closes the swirl features 202. The controller 90 receives the inputs 902, implements a method 1000 of controlling the turbine engine 10, and controls the outputs 904, as described with reference to FIG. 11 below.

FIG. 11 is a flowchart of a method 1000 of controlling the turbine engine 10 to mitigate contrail formation, according to the present disclosure. The turbine engine 10 operates as detailed above with respect to FIG. 1. During operation of the turbine engine 10, the controller 90 controls the contrail mitigation system 200 according to the method 1000. While reference is made to the contrail mitigation system 200 shown in FIGS. 3A and 3B, the method 1000 can be utilized for controlling any of the contrail mitigation systems detailed herein.

In step 1005, the method 1000 includes receiving the contrail condition indicators (e.g., the inputs 902). In particular, the controller 90 receives the contrail condition indicators. For example, the controller 90 can receive or detect at least one of the ambient temperature 910, the altitude 912, the ambient humidity 914, the air speed 916 or the engine speed 918, or the satellite communication 920 that indicates location data (e.g., GPS location) of contrail locations.

In step 1010, the method 1000 includes determining whether there is a contrail condition based on the contrail condition indicators. For example, the controller 90 can compare values for the ambient temperature 910, the altitude 912, the ambient humidity 914, the air speed 916, or the engine speed 918 to one or more threshold values that indicate the presence of contrails or can receive location data based on the satellite communication and comparing it to location data indicating that contrails will form at that location. If the controller 90 determines that there is no contrail condition or that contrail formation is not likely, the method 1000 continues to step 1005 to continually receive the contrail condition indicators. If there is a contrail condition, the method 1000 proceeds to step 1015.

The controller 90 determines that there is a contrail condition or that a contrail condition is likely based on the contrail condition indicators. In particular, the controller 90 determines that there is a contrail condition or that a contrail condition is likely if at least one of the ambient temperature 910, the altitude 912, the ambient humidity 914, the air speed 916, or the engine speed 918 is greater than or less than a contrail condition threshold. For example, contrails form or are likely to form when the ambient temperature 910 is less than an ambient temperature threshold, the altitude 912 is greater than an altitude threshold, the ambient humidity 914 is greater than a humidity threshold, the air speed 916 is greater than an air speed threshold, the engine speed 918 is greater than an engine speed threshold, or any combination of the aforementioned contrail condition indicator determinations. In some embodiments, the satellite communication 920 indicates location data (e.g., GPS location) of contrail locations at which contrails form or are likely to form along a flight path of the aircraft 95. Thus, the controller 90 can control the contrail mitigation system 200 to open the swirl features 202 at the contrail locations as the aircraft 95 approaches or arrives at the contrail locations. In some embodiments, the controller 90 determines the contrail condition based on the video feed from the camera 922. For example, if contrails are forming, the controller 90 detects the contrails in the video feed. In some embodiments, the controller 90 controls the contrail mitigation system 200 based on the operator actuating the manual switch 924. In one non-limiting example, the ambient temperature threshold is -34 degrees Celsius (C), the altitude threshold is 20,000 ft. (e.g., especially in cold, dry air), the humidity threshold is 60%, and the air speed threshold is 50 miles per hour. Such conditions indicate when contrails are occurring or are likely to occur.

In step 1015, the method 1000 includes opening the swirl features 202 when there is a contrail condition or when the contrail condition is likely to occur. For example, the controller 90 opens the swirl features 202 by an actuator rotating the tail cone 19 so that the swirl features 202 are opened or are extended by a centrifugal force. As another example, a linear actuator may directly cause the swirl features 202 to open via a linear force, such as a shaft (i.e., the LP shaft 36 or the HP shaft 34) pulling or pushing open the swirl features 202. In particular, the controller 90 controls the contrail mitigation system 200 to open the swirl features 202, as detailed above with respect to FIG. 3B.

Accordingly, the present disclosure addresses the problem of the formation of contrails, which contribute to pollution of the atmosphere and contribute to climate change. In particular, the contrail mitigation systems 100, 200, 300, 400, 500, 600, 700, and 800 create swirls in the exhaust of the turbine engine by generating swirl in the exhaust gases, generating swirl in the combustion gases, or both, as the combustion gases are exhausted from the turbine engine as exhaust gases. The swirls prevent residence time for moisture to condense on nucleation sites and, thus, prevent contrails from forming.

Further aspects are provided by the subject matter of the following clauses.

A turbine engine for an aircraft. The turbine engine comprises a combustor to combust a fuel and air mixture and to generate combustion gases flowing along a flow path, an exhaust section downstream of the combustor, the exhaust section receiving the combustion gases and exhausting the combustion gases from the turbine engine as exhaust gases flowing along a flow path, and one or more swirl features extending into the flow path of the combustion gases or the flow path of the exhaust gases, the one or more swirl features generating swirl in the exhaust gases to create swirl in an exhaust of the turbine engine.

The turbine engine of the preceding clause, wherein the exhaust section includes an outer casing, and the one or more swirl features are coupled to the outer casing.

The turbine engine of any preceding clause, wherein the exhaust section includes a tail cone, and the one or more swirl features are coupled to the tail cone.

The turbine engine of any preceding clause, wherein the exhaust section includes a bypass passage that exhausts bypass air from the turbine engine, the one or more swirl features including one or more first swirl features extending into the flow path of the combustion gases or the exhaust gases, and one or more second swirl features extending into the bypass passage to generate swirl in the bypass air as the bypass air is exhausted from the turbine engine.

The turbine engine of any preceding clause, wherein the one or more swirl features are spaced circumferentially about the exhaust section.

The turbine engine of any preceding clause, wherein the one or more swirl features are disposed at an angle with respect to a longitudinal centerline axis of the turbine engine, the angle being greater than zero degrees and less than one hundred eighty degrees.

The turbine engine of any preceding clause, wherein the one or more swirl features extend from a base to a tip, the tip being disposed in the flow path of the combustion gases or the exhaust gases to generate the swirl in the exhaust of the turbine engine.

The turbine engine of any preceding clause, wherein the base is rotatably coupled to the exhaust section such that the one or more swirl features pivot about the base to open to an opened position and to close to a closed position.

The turbine engine of any preceding clause, further comprising an actuator that opens and closes the one or more swirl features.

The turbine engine of any preceding clause, wherein the one or more swirl features are flush with a surface of the exhaust section in the closed position.

A method of creating swirl in an exhaust of a turbine engine. The method comprises combusting a fuel and air mixture to generate combustion gases flowing along a flow path, exhausting the combustion gases from the turbine engine as exhaust gases flowing along a flow path, and generating swirl in an exhaust section of the turbine engine by maintaining or inducing swirl in the flow path of the combustion gases or the flow path of the exhaust gases to create the swirl in the exhaust of the turbine engine.

The method of the preceding clause, further comprising generating the swirl in a cone of the exhaust gases with one or more swirl features.

The method of any preceding clause, wherein the exhaust section includes an outer casing, and the one or more swirl features are coupled to the outer casing.

The method of any preceding clause, wherein the exhaust section includes a tail cone, and the one or more swirl features are coupled to the tail cone.

The method of any preceding clause, wherein the exhaust section includes a bypass passage that exhausts bypass air from the turbine engine, the one or more swirl features including one or more first swirl features extending into the flow path of the combustion gases or the exhaust gases, and one or more second swirl features extending into the bypass passage, the method further comprising generating swirl in the bypass air with the one or more second swirl features as the bypass air is exhausted from the turbine engine.

The method of any preceding clause, wherein the one or more swirl features are spaced circumferentially about the exhaust section.

The method of any preceding clause, wherein the one or more swirl features are disposed at an angle with respect to a longitudinal centerline axis of the turbine engine, the angle being greater than zero degrees and less than one hundred eighty degrees.

The method of any preceding clause, wherein the one or more swirl features extend from a base to a tip, the tip being disposed in the flow path of the combustion gases or the exhaust gases, the method further comprising generating the swirl in the exhaust of the turbine engine with the tip.

The method of any preceding clause, wherein the base is rotatably coupled to the exhaust section, the method further comprising pivoting the one or more swirl features about the base to open to an opened position and to close to a closed position.

The method of any preceding clause, further comprising opening and closing the one or more swirl features with an actuator.

A contrail mitigation system for an aircraft. The contrail mitigation system comprises a combustor of a turbine engine to combust a fuel and air mixture and to generate combustion gases flowing along a flow path, an exhaust section downstream of the combustor, and one or more swirl features extending into the flow path of the combustion gases or the flow path of the exhaust gases. The exhaust section receives the combustion gases and exhausts the combustion gases from the turbine engine as exhaust gases flowing along a flow path. The one or more swirl features generate swirl in the exhaust gases to create swirl in an exhaust for mitigating a formation of contrails.

The contrail mitigation system of the preceding clause, wherein the swirl features are one or more vanes mounted in an exhaust section of the turbine engine.

The contrail mitigation system of any preceding clause, wherein the one or more swirl features are LP exit vanes, the LP exit vanes being angled with respect to an axial direction through the turbine engine to create swirl in the exhaust gases.

The contrail mitigation system of any preceding clause, wherein the swirl features are one or more flaps, fins, or claws that are rotatably coupled to a tail cone of the turbine engine.

The contrail mitigation system of any preceding clause, wherein the swirl features are struts of a turbine rear frame of the turbine engine.

The contrail mitigation system of any preceding clause, wherein the one or more swirl features each have a tip and a base, the tip being downstream of the base.

The contrail mitigation system of any preceding clause, wherein the one or more swirl features each have a tip and a base, the tip being upstream of the base.

The contrail mitigation system of any preceding clause, further comprising an actuator, wherein the actuator opens and closes the one or more swirl features by modulating a rotational speed of the tail cone.

The contrail mitigation system of the preceding clause, wherein the actuator is a pneumatic actuator, a hydraulic actuator, an electric actuator, a smart material actuator, or a shape-memory-alloy-based actuator.

The contrail mitigation system of any preceding clause, wherein the actuator controls an actuator valve, and the actuator closes the actuator valve to prevent air from flowing through a flow path of the actuator in order to close the one or more swirl features.

The contrail mitigation system of any preceding clause, wherein the actuator opens the one or more swirl features partially.

The contrail mitigation system of any preceding clause, further comprising a rotary actuator having an actuator shaft drivingly coupled to a turbine shaft, the rotary actuator rotating the tail cone of the turbine engine to activate the one or more swirl features.

The contrail mitigation system of any preceding clause, further comprising a linear actuator that pneumatically actuates the one or more swirl features to open or close the one or more swirl features.

The contrail mitigation system of any preceding clause, wherein the one or more swirl features are one or more arc-shaped flaps mounted circumferentially on the tail cone of the turbine engine, the arc-shaped flaps opening and closing when the tail cone spins.

The contrail mitigation system of any preceding clause, wherein the one or more swirl features include one or more first swirl features, wherein the one or more first swirl features are fins coupled to the tail cone of the turbine engine.

The contrail mitigation system of any preceding clause, wherein the one or more swirl features include one or more second swirl features, wherein the one or more second swirl features are fins coupled to an outer casing of the turbine engine.

The contrail mitigation system of any preceding clause, wherein the one or more first swirl features generate swirl in the exhaust gases and the one or more second swirl features generate swirl in bypass air.

The contrail mitigation system of any preceding clause, wherein the one or more swirl features are one or more flaps coupled at an aft end of a tail cone of the turbine engine, the one or more flaps each having a tip and a base and each having an open position and a closed position, the tip being radially spaced from the tail cone in the open position and being flush with the tail cone in the closed position.

The contrail mitigation system of any preceding clause, wherein the one or more swirl features are one or more flaps coupled at an aft end of a tail cone of the turbine engine, the one or more flaps each having a tip and a base and each having an open position and a closed position, the tip being radially spaced from the tail cone in the open position and being aftward from the aft end of the tail cone and in line with an inclining slope of the tail cone in the closed position.

The contrail mitigation system of any preceding clause, further comprising a linear actuator that opens the swirl features linearly without rotating the tail cone.

A control system for a turbine engine for an aircraft, the turbine engine including a combustor that generates combustion gases flowing along a flow path and an exhaust section. The exhaust section receives the combustion gases and exhausts the combustion gases from the turbine engine as exhaust gases flowing along a flow path. The control system comprises a contrail mitigation system including one or more swirl features coupled to the exhaust section and extending into the flow path of the combustion gases or the flow path of the exhaust gases, and a controller that receives one or more contrail condition indicators, determines whether there is a contrail condition based on the one or more contrail condition indicators, and opens the one or more swirl features if there is a contrail condition to generate swirl in the exhaust gases to reduce the formation of contrails.

The control system of the preceding clause, wherein the one or more swirl features are positioned on a surface of a tail cone of the exhaust section, and the controller controls the tail cone to rotate such that the flaps open when there is a contrail condition.

The control system of any preceding clause, wherein the controller controls the tail cone to rotate at a first speed such that the one or more swirl features open partially.

The control system of any preceding clause, wherein the controller controls the tail cone to rotate at a second speed greater than the first speed such that the one or more swirl features open fully.

The control system of any preceding clause, wherein the exhaust section includes an outer casing, and the one or more swirl features are positioned on the outer casing.

The control system of any preceding clause, further comprising an aft-facing camera, wherein the one or more contrail condition indicators include a video feed of the aft-facing camera.

The control system of any preceding clause, wherein the contrail mitigation system includes a linear actuator coupled to the one or more swirl features, and the controller controls the linear actuator to open the one or more swirl features.

The control system of any preceding clause, wherein the contrail mitigation system includes one or more sensors that sense at least one of an ambient temperature about the turbine engine, an altitude of the aircraft, an ambient humidity about that turbine engine, an air speed of the aircraft, or an engine speed of the turbine engine, and the one or more contrail condition indicators include the at least one of the ambient temperature, the altitude, the ambient humidity, the air speed, or the engine speed.

The control system of any preceding clause, wherein the control system includes a contrail condition threshold, and the controller opens the one or more swirl features if the ambient temperature is less than the contrail condition threshold.

The control system of any preceding clause, wherein the control system includes a contrail condition threshold, and the controller opens the one or more swirl features if at least one of the altitude, the ambient humidity, the air speed, or the engine speed is greater than the contrail condition threshold.

The control system of any preceding clause, wherein the control system includes a satellite communication providing at least one of location data or weather data to the controller, the at least one of the location data or the weather data indicating whether a contrail condition is likely to form, and the controller controls the one or more swirl features to open when the contrail condition is likely to form.

The control system of any preceding clause, wherein the contrail mitigation system includes a manual switch, and the controller controls the one or more swirl features to open upon actuation of the manual switch.

A method of operating the turbine engine of any preceding clause via a contrail mitigation system, the method comprising, receiving, at a controller, one or more contrail condition indicators, determining whether there is a contrail condition based on the one or more contrail condition indicators, and opening the one or more swirl features if there is a contrail condition to generate swirl in a cone of the exhaust gases to reduce the formation of contrails.

The method of the preceding clause, wherein the one or more swirl features are positioned on a surface of a tail cone of the exhaust section, the method further comprising rotating the tail cone such that the flaps open when there is a contrail condition.

The method of any preceding clause, further comprising rotating the tail cone at a first speed such that the one or more swirl features open partially.

The method of the preceding clause, further comprising rotating the tail cone at a second speed greater than the first speed such that the one or more swirl features open fully.

The method of any preceding clause, wherein the exhaust section includes an outer casing, and the one or more swirl features are positioned on the outer casing.

The method of any preceding clause, further comprising an aft-facing camera, wherein the one or more contrail condition indicators include a video feed of the aft-facing camera.

The method of any preceding clause, wherein the contrail mitigation system includes a linear actuator coupled to the one or more swirl features, the method further comprising opening the one or more swirl features with the linear actuator.

The method of any preceding clause, wherein the contrail mitigation system includes one or more sensors that sense at least one of an ambient temperature about the turbine engine, an altitude of the aircraft, an ambient humidity about that turbine engine, an air speed of the aircraft, or an engine speed of the turbine engine, and the one or more contrail condition indicators include the at least one of the ambient temperature, the altitude, the ambient humidity, the air speed, or the engine speed.

The method of any preceding clause, further comprising opening the one or more swirl features if the ambient temperature is less than a contrail condition threshold.

The method of any preceding clause, further comprising opening the one or more swirl features if at least one of the altitude, the ambient humidity, the air speed, or the engine speed is greater than the contrail condition threshold.

The method of any preceding clause, wherein a satellite communication provides at least one of location data or weather data to the controller, and the at least one of the location data or the weather data indicates whether a contrail condition is likely to form, the method further comprising opening the one or more swirl features when the contrail condition is likely to form.

The method of any preceding clause, wherein the contrail mitigation system includes a manual switch, the method further comprising opening the one or more swirl features upon actuation of the manual switch.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbine engine for an aircraft, the turbine engine comprising:
a combustor to combust a fuel and air mixture and to generate combustion gases flowing along a flow path;
an exhaust section downstream of the combustor, the exhaust section receiving the combustion gases and exhausting the combustion gases from the turbine engine as exhaust gases flowing along a flow path; and
one or more swirl features extending into the flow path of the combustion gases or the flow path of the exhaust gases, the one or more swirl features generating swirl in the exhaust gases to create swirl in an exhaust of the turbine engine.

2. The turbine engine of claim 1, wherein the exhaust section includes an outer casing, and the one or more swirl features are coupled to the outer casing.

3. The turbine engine of claim 1, wherein the exhaust section includes a tail cone, and the one or more swirl features are coupled to the tail cone.

4. The turbine engine of claim 1, wherein the exhaust section includes a bypass passage that exhausts bypass air from the turbine engine, the one or more swirl features including one or more first swirl features extending into the flow path of the combustion gases or the exhaust gases, and one or more second swirl features extending into the bypass passage to generate swirl in the bypass air as the bypass air is exhausted from the turbine engine.

5. The turbine engine of claim 1, wherein the one or more swirl features are spaced circumferentially about the exhaust section.

6. The turbine engine of claim 1, wherein the one or more swirl features are disposed at an angle with respect to a longitudinal centerline axis of the turbine engine, the angle being greater than zero degrees and less than one hundred eighty degrees.

7. The turbine engine of claim 1, wherein the one or more swirl features extend from a base to a tip, the tip being disposed in the flow path of the combustion gases or the exhaust gases to generate the swirl in the exhaust of the turbine engine.

8. The turbine engine of claim 7, wherein the base is rotatably coupled to the exhaust section such that the one or more swirl features pivot about the base to open to an opened position and to close to a closed position.

9. The turbine engine of claim 8, wherein the one or more swirl features are flush with a surface of the exhaust section in the closed position.

10. The turbine engine of claim 8, further comprising an actuator that opens and closes the one or more swirl features.

11. The turbine engine of claim 10, wherein the actuator includes at least one of a rotary actuator that rotates a portion of the exhaust section to open and to close the one or more swirl features or a linear actuator that linearly opens and closes the one or more swirl features.

12. A method of creating swirl in an exhaust of a turbine engine, the method comprising:
combusting a fuel and air mixture to generate combustion gases flowing along a flow path;
exhausting the combustion gases from the turbine engine as exhaust gases flowing along a flow path; and
generating swirl in an exhaust section of the turbine engine by maintaining or inducing swirl in the flow path of the combustion gases or the flow path of the exhaust gases to create the swirl in the exhaust of the turbine engine.

13. The method of claim 12, further comprising generating the swirl in a cone of the exhaust gases with one or more swirl features.

14. The method of claim 13, wherein the exhaust section includes an outer casing, and the one or more swirl features are coupled to the outer casing.

15. The method of claim 13, wherein the exhaust section includes a tail cone, and the one or more swirl features are coupled to the tail cone.

16. The method of claim 13, wherein the exhaust section includes a bypass passage that exhausts bypass air from the turbine engine, the one or more swirl features including one or more first swirl features extending into the flow path of the combustion gases or the exhaust gases, and one or more second swirl features extending into the bypass passage, the method further comprising generating swirl in the bypass air with the one or more second swirl features as the bypass air is exhausted from the turbine engine.

17. The method of claim 13, wherein the one or more swirl features are spaced circumferentially about the exhaust section.

18. The method of claim 13, wherein the one or more swirl features are disposed at an angle with respect to a longitudinal centerline axis of the turbine engine, the angle being greater than zero degrees and less than one hundred eighty degrees.

19. The method of claim 13, wherein the one or more swirl features extend from a base to a tip, the tip being disposed in the flow path of the combustion gases or the exhaust gases, the method further comprising generating the swirl in the exhaust of the turbine engine with the tip.

20. The method of claim 19, wherein the base is rotatably coupled to the exhaust section, the method further comprising pivoting the one or more swirl features about the base to open to an opened position and to close to a closed position.
